(19) United States
(12) Patent Application Publication
(10) Pub. No.: US 2002/0160096 A1
(43) Pub. Date: Oct. 31, 2002

(54) Peanut butter onion mixture

(76) Inventor: Orville A. Moiten, Dorchester, MA (US)

Correspondence Address: LAMBERT & ASSOCIATES, P.L.L.C., 92 STATE STREET, BOSTON, MA, 02109-2004, US

(21) Appl. No.: 09/843,671

(22) Filed: Apr. 27, 2001

(51) Int. Cl. A23L 1/38

(52) U.S. Cl. 426/633

(57) ABSTRACT

A peanut butter onion mixture which substantially enhances the flavor and retains the texture qualities of peanut butter, comprising a quantity of peanut butter and a quantity of onion. The quantity of peanut butter utilized may be a natural peanut butter or an imitation peanut butter. The quantity of onion utilized may comprise crushed onion, a suspension of crushed onion, onion pulp and onion juice, or onion juice alone. Methods of producing said peanut onion mixture for different embodiments of the onion mixture.

### FIELD OF THE INVENTION

The present invention relates to peanut butter products and in particular, to a peanut butter onion mixture and a method of forming a peanut butter onion mixture.

### BACKGROUND OF THE INVENTION

For years people have been enjoying the flavor of foods that include crushed peanuts or products of crushed peanuts, such as peanut butter. However, problems have been encountered with maintaining the consistency of peanut butter when mixed with other foods and then refrigerated.

Another problem encountered when mixing peanut butter with other products centers around the digestive qualities of peanut butter. Although people enjoy the taste of peanut butter, many people are prone to indigestion after eating products containing peanut butter.

### SUMMARY OF THE INVENTION

The instant invention overcomes the above-described problems by creating a onion mixture that substantially retains the taste and consistency of peanut butter, but is easier on digestion and retains consistency upon refrigeration.

It is therefore an object of this invention to create a peanut butter onion mixture that enhances the flavor of peanut butter.

It is a further object of this invention to create a peanut butter onion mixture that retains the consistency qualities of peanut butter when mixed with other substances and then refrigerated.

It is a further object of this invention to create a peanut butter onion mixture that exhibits more favorable digestive qualities than plain peanut butter.

Other objects, features and advantages of the invention will be apparent from the detailed disclosure.

### DETAILED DESCRIPTION OF THE PREFERRED EMBODIMENT

A peanut butter onion mixture that substantially enhances the flavor and retains the texture qualities of peanut butter, comprising a quantity of peanut butter and a quantity of onion, wherein the ratio of quantity of peanut butter to quantity of onion is 5 to 4 is disclosed. The quantity of peanut butter utilized may be a natural peanut butter. The quantity of peanut butter utilized may be an imitation peanut butter. The quantity of onion utilized may comprise crushed onion, a suspension of crushed onion, onion pulp and onion juice, or onion juice alone.

The peanut butter onion mixture may be mixed with other substances to form a new onion mixture and upon refrigeration of the new onion mixture, the spreadability qualities the new onion mixture possessed before refrigeration will be retained.

A method of producing the above described peanut butter onion mixture has been established comprising: milling a quantity of peanut butter, pumping said quantity of peanut butter into a deaerator unit, deaerating said quantity of peanut butter, pumping said quantity of peanut butter into a heat exchanger, cooling said quantity of peanut butter, feeding a quantity of crushed onion into said quantity of peanut butter to create a peanut butter onion mixture and pumping said peanut onion mixture to a filler unit for filling. The peanut butter onion mixture may have a ratio of peanut butter to crushed onion of 5 to 4. The quantity of crushed onion may be comprised of crushed onion, onion pulp and onion juice. The process temperatures should range from 87 C. (190° F.) for deaerating and then cooling to 29 C. (85° F.) for addition of crushed onion and filling.

In another embodiment, a method of producing the peanut butter onion mixture has been established comprising: milling a quantity of peanut butter, feeding a quantity of onion juice into said quantity of peanut butter, mixing said quantity of onion juice and said quantity of peanut butter to create a peanut butter onion mixture, pumping said peanut butter onion mixture into a deaerator unit, deaerating said quantity of peanut butter, pumping said quantity of peanut butter into a heat exchanger, cooling said quantity of peanut butter and finally pumping said peanut onion mixture to a filler unit for filling. The process temperatures should range from 87 C. (190° F.) for deaerating and mixing of raw onion juice then cooling to 29 C. (85° F.) for filling. When raw onion juice is utilized, the ratio of the quantity of peanut butter to the quantity of onion juice can be 2 to 1.

The above embodiments considered, it will be observed that numerous different configurations and alternatives may be achieved with out straying from the scope of the original invention. With this in mind, it is stated that no limitation with respect to the specific apparatus illustrated herein is intended or should be inferred. It is, of course, intended to cover by the appended claims all such modifications as are covered by the scope of the claims.

I claim:

1. A peanut butter onion mixture that substantially enhances the flavor and retains the texture qualities of peanut butter, comprising a quantity of peanut butter and a quantity of onion.

2. The peanut butter onion mixture of claim 1 wherein said quantity of peanut butter is a natural peanut butter.

3. The peanut butter onion mixture of claim 1 wherein said quantity of peanut butter is an imitation peanut butter.

4. The peanut butter onion mixture of claim 1 wherein said quantity of onion comprises crushed onion.

5. The peanut butter onion mixture of claim 1 wherein said quantity of onion comprises onion juice.

6. The peanut butter onion mixture of claim 1 wherein said quantity of onion comprises a suspension of crushed onion, onion pulp and onion juice.

7. The peanut butter onion mixture of claim 1 wherein upon mixture of said peanut butter onion mixture with other substances to form a new onion mixture and refrigeration of said new onion mixture, the spreadability qualities said new onion mixture possessed before refrigeration will be retained.

8. The peanut butter onion mixture of claim 1 wherein the ratio of said quantity of peanut butter to said quantity of onion is 5 to 4.

9. A method of producing a peanut butter onion mixture comprising:
milling a quantity of peanut butter;
pumping said quantity of peanut butter into a deaerator unit;
deaerating said quantity of peanut buffer;
pumping said quantity of peanut butter into a heat exchanger;
cooling said quantity of peanut butter;
feeding a quantity of crushed onion into said quantity of peanut butter to create a peanut butter onion mixture;
pumping said peanut onion mixture to a filler unit for filling.

10. The method of producing a peanut butter onion mixture of claim 9 wherein said peanut butter onion mixture has a ratio of said quantity of peanut butter to said quantity of onion of 5 to 4.

11. The method of producing a peanut butter onion mixture of claim 10 wherein said quantity of crushed onion is comprised of crushed onion, onion pulp and onion juice.

12. A method of producing a peanut butter onion mixture comprising:
milling a quantity of peanut butter;
feeding a quantity of onion juice into said quantity of peanut butter;
mixing said quantity of onion juice and said quantity of peanut to create a peanut butter onion mixture;
pumping said peanut butter onion mixture into a deaerator unit;
deaerating quantity of peanut butter onion mixture;
pumping said peanut butter onion mixture into a heat exchanger;
cooling said peanut butter onion mixture;
pumping said peanut onion mixture to a filler unit for filling.

13. The method of producing said peanut butter onion mixture of claim 12 wherein said peanut butter onion mixture has a ratio of said quantity of peanut butter to said quantity of onion juice of 2 to 1.
